(19) United States
(12) Patent Application Publication
(10) Pub. No.: US 2022/0201808 A1
(43) Pub. Date: Jun. 23, 2022

(54) INDUCTION HEATING DEVICE PROVIDING IMPROVED USER EXPERIENCE AND USER INTERFACE

(71) Applicant: LG Electronics Inc., Seoul (KR)

(72) Inventors: Hyeonna HAN, Seoul (KR); Mijin JUNG, Seoul (KR)

(21) Appl. No.: 17/604,644

(22) PCT Filed: Apr. 16, 2020
(86) PCT No.: PCT/KR2020/005086

§ 371 Date: Oct. 18, 2021

(30) Foreign Application Priority Data
Apr. 18, 2019 (KR) 10-2019-0045753

(51) Int. Cl. H05B 6/06; H05B 6/12; G06F 3/041

(52) U.S. Cl. CPC H05B 6/065; H05B 6/1281; G06F 3/0416; G06F 3/0412; H05B 6/1218

(57) ABSTRACT

Disclosed herein is an induction heating device that provides improved user experience and user interface, the induction heating device including a case, a plurality of working coils provided in the case, a cover plate which is coupled to an upper end of the case and where an object subject to heating heated by at least one of the plurality of working coils is placed on an upper surface thereof, an input interface flatly buried into the upper surface of the cover plate, configured to receive a touch input from a user, and configured to display a specific image, a first control module configured to sense which one of the plurality of working coils has the object subject to heating at an upper side thereof, and a second control module configured to control the input interface such that a coil image of each of the plurality of working coils is displayed on the input interface, wherein the second control module receives information on a position of the sensed object subject to heating from the first control module, determines whether the sensed object subject to heating is concentrically placed on the basis of the information on the position of the sensed object subject to heating, and controls the input interface on the basis of results of the determination and on the basis of the information on the position of the sensed object subject to heating such that a burner image for the object subject to heating is displayed on the input interface.

### TECHNICAL FIELD

The present invention relates to an induction heating device that can provide improved user experience (UX) and user interface (UI).

### BACKGROUND ART

Various types of cooking apparatuses are used to heat food at homes and restaurants. Conventionally, gas ranges that are fueled by gas have been widely used. However, in recent years, apparatuses that are used to heat an object subject to heating such as a vessel including a pot, using electricity instead of gas, have been used.

Methods for heating an object subject to heating using electricity are broadly classified as a resistance heating method and an induction heating method. The resistance heating method is a method by which an object subject to heating is heated by heat that is generated when electric current flows through a metallic resistance wire, or through a non-metallic heating element such as silicon carbide and that then is delivered to the object subject to heating (e.g., a cooking vessel) through radiation or conduction. The induction heating method is a method by which an object subject to heating itself is heated by eddy currents that are generated in the object subject to heating, which is comprised of metallic ingredients, using a magnetic field that is generated around a coil when a predetermined magnitude of high-frequency power is supplied to the coil.

An induction heating device to which the method of induction heating is applied is generally provided with a working coil respectively in a corresponding area to heat each of the plurality of objects subject to heating (e.g., a cooking vessel).

However, recently, an induction heating device (i.e., a zone free-type induction heating device), in which a plurality of working coils simultaneously heat a single object, has been widely used. The zone free-type induction heating device may inductively heat an object subject to heating regardless of a size and position of the object subject to heating in an area where a plurality of working coils are provided.

A zone free-type induction heating device is disclosed in Japanese Patent No. 6052585B2.

The zone free-type induction heating device may be provided with an input interface. The input interface, which is a module for inputting heating intensity or driving time and the like desired by a user, may be implemented in various different forms including a physical button or a touch panel and the like. Further, the input interface may be provided with a display panel (i.e., a touch screen-type panel) that displays a driving state (e.g., a burner image for an object subject to heating) of the induction heating device.

However, it is difficult for the user to figure out about an optimal heating position or an efficient heating position of an object subject to heating as the user may not know about an arrangement state of a working coil. Further, in case the user eccentrically places an object subject to heating at an upper side of a working coil, problems such as decreased energy efficiency and increased cooking time and the like may occur.

### DETAILED DESCRIPTION OF INVENTION

### Technical Problems

The present invention is directed to an induction heating device that may improve accuracy of a concentric arrangement of an object subject to heating by a user.

The present invention is also directed to an induction heating device that may provide improved user experience (UX) and user interface (UI).

Aspects of the present invention are not limited to the above-described ones. Additionally, other aspects and advantages that have not been mentioned may be clearly understood from the following description and may be more clearly understood from embodiments. Further, it will be understood that the aspects and advantages of the present invention may be realized via means and combinations thereof that are described in the appended claims.

### Solutions to Problem

According to an embodiment, an induction heating device may show an arrangement state of a plurality of working coils to a user through an input interface and an indicator, thereby improving accuracy of a concentric arrangement of an object subject to heating by the user.

According to an embodiment, an induction heating device may include an input interface that is flatly buried into an upper surface of a cover plate, that receives a touch input from a user and that displays a specific image, a second control module that controls a specific image displayed on the input interface on the basis of the touch input supplied by the input interface, and a first control module that controls the driving of at least one of a plurality of working coils on the basis of the touch input supplied by the second control module, thereby making it possible to provide improved user experience and user interface.

### Effects of the Invention

The induction heating device may improve accuracy of a concentric arrangement of an object subject to heating by a user, thereby reducing the possibility that the object subject to heating is eccentrically placed at an upper side of a working coil and solving problems such as decreased energy efficiency and increased cooking time and the like caused by the eccentric arrangement of the object subject to heating.

The induction heating device may provide improved user experience and user interface, thereby enhancing user convenience under different conditions.

### DESCRIPTION OF THE DRAWINGS

FIG. 1 is a perspective view illustrating an induction heating device according to an exemplary embodiment of the present invention.

FIG. 2 is a plane view illustrating a state in which some components of the induction heating device in FIG. 1 are omitted according to an exemplary embodiment of the present invention.

FIGS. 3 and 4 are partially enlarged views illustrating the induction heating device in FIG. 2 according to an exemplary embodiment of the present invention.

FIG. 5 is a block diagram for describing a flow of control of the induction heating device in FIG. 1 according to an exemplary embodiment of the present invention.

FIGS. 6 to 11 are views for describing a display method of an arrangement state of a working coil of the induction heating device in FIG. 1 according to an exemplary embodiment of the present invention.

### DETAILED DESCRIPTION OF EMBODIMENTS

The above-described aspects, features and advantages are specifically described with reference to the accompanying drawings hereunder such that one having ordinary skill in the art to which the present invention pertains may easily implement the technical spirit of the invention. In describing the invention, detailed description of known technologies in relation to the invention is omitted if it is deemed to make the gist of the present invention unnecessarily vague. Below, preferred embodiments of the present invention are specifically described with reference to the accompanying drawings. Throughout the drawings, identical reference numerals denote identical or similar components.

When any component is described as being “at an upper portion (or a lower portion)” of a component, or “on (or under)” a component, any component may be placed on the upper surface (or the lower surface) of the component, and an additional component may be interposed between the component and any component placed on (or under) the component.

When a component is described as being “connected,” “coupled” or “connected” to another component, the components may be directly connected or coupled; however, it is also to be understood that an additional component may be “interposed” between the components, or the components may be “connected,” “coupled” or “connected” through an additional component.

Below, an induction heating device according to an embodiment is described.

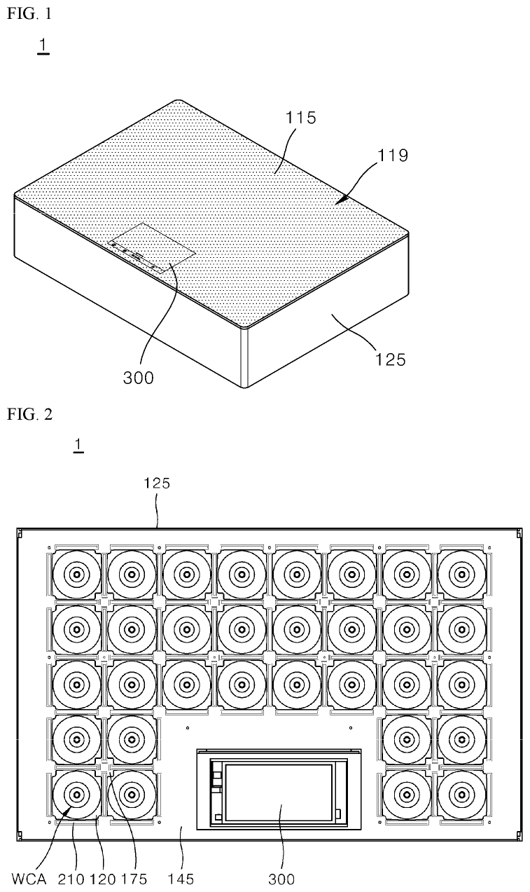

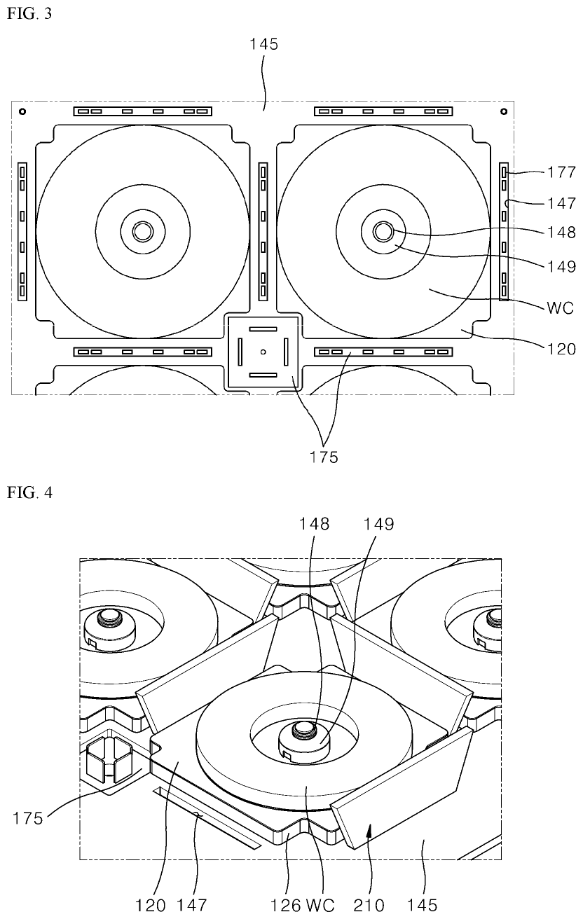

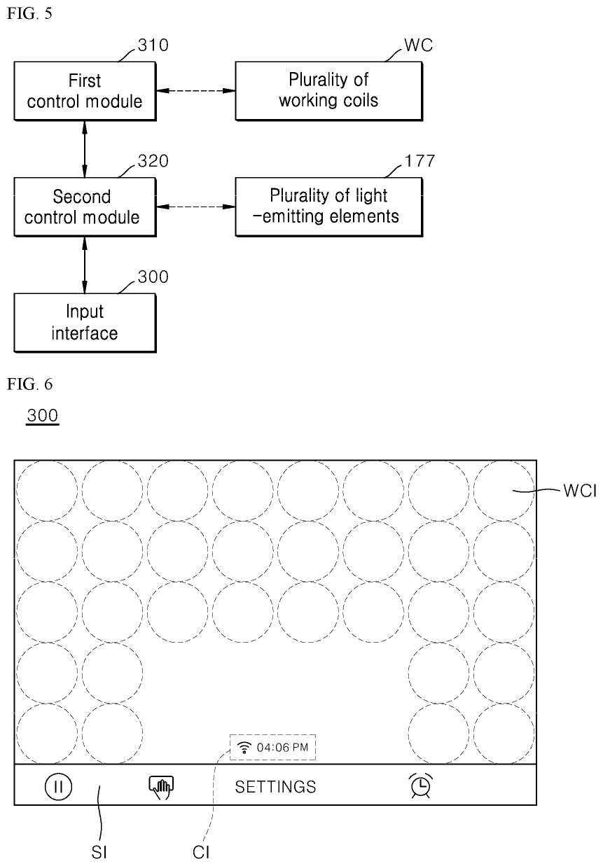

FIG. 1 is a perspective view illustrating an induction heating device according to an exemplary embodiment of the present invention. FIG. 2 is a plane view illustrating a state in which some components of the induction heating device in FIG. 1 are omitted according to an exemplary embodiment of the present invention. FIGS. 3 and 4 are partially enlarged views illustrating the induction heating device in FIG. 2 according to an exemplary embodiment of the present invention. FIG. 5 is a block diagram for describing a flow of control of the induction heating device in FIG. 1 according to an exemplary embodiment of the present invention.

For convenience of description, FIG. 2 is a view illustrating an induction heating device without a cover plate 119 in FIG. 1, and FIGS. 3 and 4 are views illustrating a state in which some components (e.g., a light guide) of the induction heating device 1 in FIG. 2 are omitted.

Referring to FIGS. 1 to 5, the induction heating device 1 according to an exemplary embodiment of the present invention may include a case 125, a cover plate 119, a base plate 145, an indicator substrate 175, an indicator (i.e., an indicator comprised of a light-emitting element 177 and a light guide 210), an input interface 300, a first control module 310, a second control module 320, a working coil assembly (WCA).

The case 125 may be thermally insulated to prevent heat generated by a working coil (WC) from leaking outwards.

The case 125 may be provided with various components such as the working coil assembly (WCA), the base plate 145, the indicator substrate 175, the light-emitting element 177 and the light guide 210 and the like that constitute the induction heating device 1.

The case 125 may be further provided with various devices (e.g., a power supply that supplies AC power, a rectifier that rectifies AC power of the power supply into DC power, an inverter that converts DC power rectified by the rectifier into a resonance current through a switching operation and that supplies the resonance current to a working coil (WC), a relay or a semiconductor switch that turns on or turns off a working coil (WC), and the like) in relation to the driving of the working coil (WC), an indicator substrate supporter (not illustrated) where an indicator substrate 175 is installed, a blowing fan (not illustrated) that cools heat generated in a working coil (WC) or a light-emitting element 177 and the like. Detailed description in relation to those devices is omitted.

The cover plate 119 may be coupled to an upper end of the case 125 and may shield an inside of the case 125. An object subject to heating (not illustrated) may be placed on an upper surface of the cover plate 119.

Specifically, the cover plate 119 may include an upper plate 115 (i.e., the upper surface of the cover plate 119) for placing an object subject to heating such as a cooking vessel, and heat generated in the working coil (WC) may be delivered to the object subject to heating through the upper plate 115.

The upper plate 115, for example, may be made of a glass material, and an input interface 300 that receives a touch input from a user and delivers the touch input to the second control module 320 may be installed on the upper plate 115.

The input interface 300 may be flatly buried into the upper surface of the cover plate 119, i.e., may be flatly buried into the upper plate 115 (That is, the input interface 300 may be installed flatly on the same flat surface as the upper plate 115.), and may be controlled by the second control module 320 to display a specific image (e.g., a burner image, a remaining heat image, a heating intensity image, a timer image, a working coil image and the like.). Further, the input interface 300 may receive a touch input from the user and may supply the received touch input to the second control module 320.

The input interface 300, which is a module for inputting heating intensity or heating time and the like desired by the user, may be implemented in various different forms such as a physical button or a touch panel and the like. Additionally, the input interface 300 may be provided with a display panel (i.e., a touch screen-type panel) that displays a driving state and the like of the induction heating device 1.

The input interface 300 may deliver a touch input supplied by the user to the second control module 320, and the second control module 320 may deliver the touch input to the first control module 310. Detailed description in relation to this is described hereunder.

The working coil assembly (WCA) may include a working coil (WC), a ferrite core 126, and a mica sheet 120 (i.e., a first mica sheet).

In case the induction heating device 1 is a zone free-type induction heating device, a plurality of working coil assemblies (WCA), as illustrated in FIG. 2, may be provided, and the plurality of working coil assemblies (e.g., WCA) may be spaced a predetermined distance apart from each other.

A plurality of working coils (e.g., WC) included in the plurality of working coil assemblies (e.g., WCA) may be controlled individually or in a group.

Specifically, the plurality of working coils, for example, may be controlled in a group such as a first working coil group (one or more working coils) and a second working coil group (one or more working coils), and each working coil group may be independently controlled by an individual inverter. Working coils included in each working coil group may be independently controlled by the above-described relay or semiconductor switch.

For convenience of description, a single working coil assembly (WCA) is described as an example.

The working coil (WC) may be comprised of wires that are wound in a ring shape a plurality of times, and may generate an AC magnetic field. Additionally, the driving of the working coil (WC) may be controlled by the first control module 310, and a mica sheet 120 and a ferrite core 126 may be consecutively disposed at a lower side of the working coil (WC).

The ferrite core 126 may be disposed at the lower side of the working coil (WC), and a core hole (not illustrated) may be formed at a central portion of the ferrite core 126 to perpendicularly overlap with a ring-shaped inside of the working coil (WC).

Specifically, a base plate 145 may be disposed at a lower side of the ferrite core 126, and the mica sheet 120 may be disposed between the ferrite core 126 and the working coil (WC).

As illustrated in FIGS. 3 and 4, a packing gasket 149 may be coupled to the corer hole such that the ferrite core 126 is fixed onto the base plate 145. A sensor 148 may be installed at an upper end of the packing gasket 149. The sensor 148 may sense a temperature of the upper plate 115, and a temperature or an operation and the like of the working coil (WC), and may deliver temperature information or operation information and the like to the above-described second control module 320 or the first control module 310.

The ferrite core 126 may be fixed to the mica sheet 120 through a sealant, and may spread an AC magnetic field generated in the working coil (WC).

The mica sheet 120 (i.e., a first mica sheet) may be disposed between the working coil (WC) and the ferrite core 126, and may be provided with a sheet hole (not illustrated) at a central portion thereof to perpendicularly overlap with the ring-shaped inside of the working coil (WC).

The mica sheet 120 may be fixed to the working coil (WC) and the ferrite core 126 through a sealant, and may prevent heat generated by the working coil (WC) from being directly delivered to the ferrite core 126.

Though not illustrated in the drawings, the working coil assembly (WCA) may further include a second mica sheet (not illustrated) that is fixed to the upper end of the working coil (WC) through a sealant and that is provided with a second sheet hole (not illustrated) formed at a central portion of the second mica sheet to perpendicularly overlap with the ring-shaped inside of the working coil (WC).

For convenience of description, detailed description in relation to the second mica sheet is omitted.

The working coil assembly (WCA) may be installed at the base plate 145.

Specifically, the ferrite core 126, the mica sheet 120, and the working coil (WC) may be consecutively stacked on the base plate 145. An indicator substrate 175 may be placed to be spaced apart from the base plate 145 at a lower side of the base plate 145.

The base plate 145, for example, may be integrally formed and may be made of aluminum (Al), but not be limited.

Further, the base plate 145 may be provided with a light guide 210.

Specifically, the light guide 210 may be provided around the working coil (WC) at the base plate 145. That is, four light guides (e.g., 210) per a single working coil (WC) may be installed around the working coil (WC).

The light guide 210 may display light, emitted from a light-emitting element 177, through a light-emitting surface (i.e., an upper surface) of an upper end thereof, and may display whether the working coil (WC) operates and may display output intensity (i.e., heating intensity) of the working coil (WC). Each light guide 210 may be installed at each light guide installation hole 147 formed at the base plate 145.

The light guide installation hole 147 for installing a light guide 210, as illustrated in FIGS. 3 and 4, may be formed at the base plate 145 in a space between the ferrite cores. That is, the light guide installation hole 147 may be formed at the base plate 145 along a position where the light guide 210 is installed. Accordingly, the light guide installation hole 147 may also be formed around a working coil (WC), and four light guide installation holes (e.g., 147) per a single working coil (WC) may be formed around the working coil (WC).

The number of the light guide installation holes 147 may be the same as the number of the light guides 210.

Light emitted from a light-emitting element 177 installed at the indicator substrate 175 may be delivered to the light guide 210 through the light guide installation hole 147. Accordingly, the light guide 210 may display whether the working coil (WC) operates and may display output intensity (i.e., heating intensity) of the working coil (WC).

The indicator substrate 175 may be spaced apart from the base plate 145 at the lower side of the base plate 145, and a light-emitting element 177 may be installed at the indicator substrate 175.

Specifically, the indicator substrate 175 may be installed on an indicator substrate supporter (not illustrated) to be spaced downwards apart from the base plate 145. The indicator substrate 175, for example, may be implemented in the form of a printed circuit board (PCB). Though not illustrated in the drawings, the indicator substrate 175 may be further provided with various components for driving the light-emitting element 177.

As illustrated in FIG. 3, a plurality of light-emitting elements (e.g., 177) may be provided and may be installed at the indicator substrate 175 (i.e., a lower side of the light guide 210) through the light guide installation hole 147 to be exposed upwards. Accordingly, light emitted from the light-emitting element 177 may be delivered to the light guide 210 through the light guide installation hole 147.

The plurality of light-emitting elements (e.g., 177), for example, may include a light-emitting diode (LED) respectively, and may be controlled by the second control module 320.

The first control module 310 may control the driving of the plurality of working coils (e.g., WC).

The first control module 310 may detect a degree of a reduction in resonance currents flowing in each working coil, and, on the basis of results of the detection, may sense a working coil that has an object subject to heating at an upper side thereof.

In case an object subject to heating is placed on a working coil (WC), the entire resistance may be increased due to resistance of the object subject to heating. Accordingly, a degree to which a resonance current flowing in the working coil (WC) is reduced may be increased.

The first control module 310, as described above, detects a resonance current flowing in a working coil (WC), and, on the basis of a value of the detection, may detect whether an object subject to heating is placed on the working coil (WC).

Certainly, the first control module 310 may sense an object subject to heating using another method. In the embodiment, the above-described method used to detect an object subject to heating is described as an example.

The first control module 310 may supply information of a position of the sensed object subject to heating to the second control module 320 and may receive a user's touch input from the second control module 320.

Certainly, the first control module 310 may control the driving of at least one of the plurality of working coils (e.g., WC) on the basis of the user's touch input supplied by the second control module 320.

The information on the position of the sensed object subject to heating may include information on a degree of a reduction in resonance currents flowing in each working coil where an object subject to heating is sensed among the plurality of working coils.

The second control module 320 may control an image displayed on the input interface 300 and the driving of the plurality of light-emitting elements (e.g., 177).

Specifically, the second control module 320 may receive a user's touch input from the input interface 300, and may supply the received touch input to the first control module 310 or may control the input interface 300 or the light-emitting element 177 on the basis of the received touch input.

The second control module 320 may receive information on a position of an object subject to heating from the first control module 310 and may control the input interface 300 such that a burner image for the object subject to heating is displayed on the input interface 300 on the basis of the received information on the position of the object subject to heating.

Specifically, the second control module 320 may receive the information on the position of the sensed object subject to heating from the first control module 310, and, on the basis of the information on the position of the sensed object subject to heating, may determine whether the sensed object subject to heating is concentrically placed, and, on the basis of results of the determination and the information on the position of the sensed object subject to heating, may control the input interface 300 such that a burner image for the object subject to heating is displayed on the input interface 300.

Certainly, the second control module 320 may control (i.e., turn on) driving of a light-emitting element placed around a lower side of the sensed object subject to heating among the plurality of light-emitting elements on the basis of the received information on the position of the object subject to heating.

Additionally, when power starts to be supplied from the above-described power supply (i.e., when the induction heating device 1 is turned on), the second control module 320 may turn on or may alternately turn on and turn off all the plurality of light-emitting elements for a predetermined period.

The second control module 320, as described above, may perform various control functions. Detailed description in relation to this is described hereunder.

The induction heating device 1 according to an embodiment may also perform the function of wireless power transmission on the basis of the above-described configurations and features.

In recent years, technologies for wirelessly supplying power have been developed and have been widely used for various types of electronic devices. An electronic device, to which the wireless power transmitting technology is applied, can be charged only by being placed on a charge pad without connecting to an additional charge connector. Accordingly, the electronic device, to which the wireless power transmitting technology is applied, requires no cord or no charger, thereby ensuring improved mobility and a reduced size and weight.

The wireless power transmitting technology can be broadly classified as an electromagnetic induction technology using a coil, and a resonance technology using resonance, a radio emission technology for converting electric energy into microwaves and delivering the microwaves and the like. Among the technologies, the electromagnetic induction technology is a technology in which power is transmitted using electromagnetic induction between a primary coil provided at an apparatus for wirelessly transmitting power (e.g., a working coil (WC)) and a secondary coil provided at an apparatus for wirelessly receiving power.

The induction heating technology of an induction heating device 1 is substantially the same as the wireless power transmitting technology using electromagnetic induction, in that an object subject to heating is heated through electromagnetic induction.

Thus, the induction heating device 1 according to an embodiment may perform the functions of wireless power transmission as well as induction heating. Further, the second control module 320 or the first control module 310 may control induction heating mode or wireless power transmitting mode. Accordingly, when necessary, the function of induction heating or the function of wireless power transmission may be optionally performed.

The induction heating device 1 according to an embodiment has the above-described configurations and features. Below, a display method of an arrangement state of a working coil of the induction heating device 1 is described with reference to FIGS. 6 to 11.

FIGS. 6 to 11 are views for describing a display method of an arrangement state of a working coil of the induction heating device in FIG. 1.

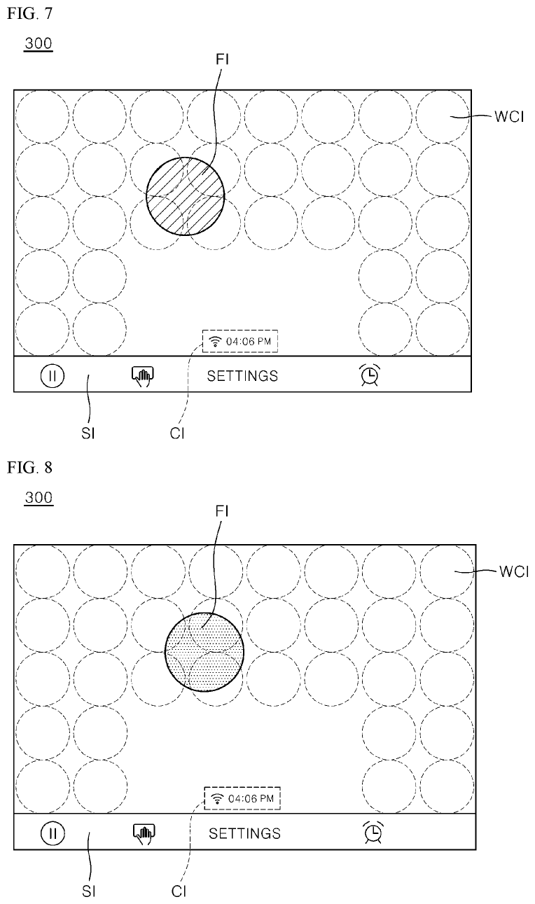

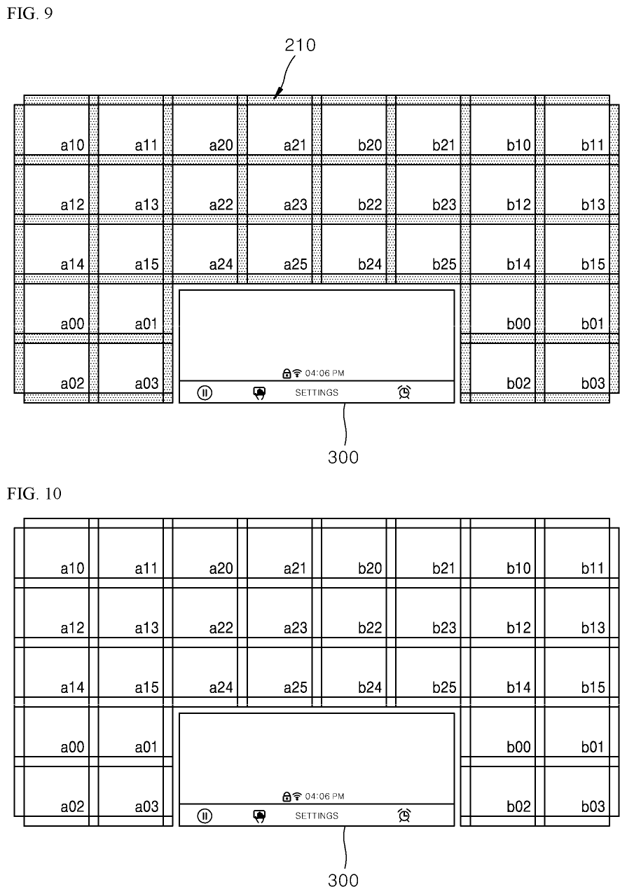

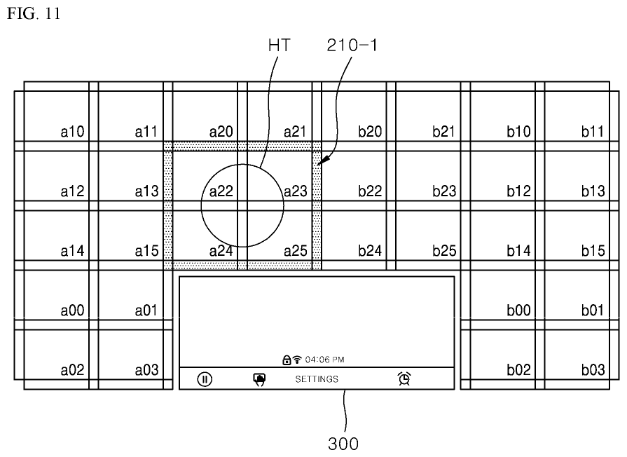

FIGS. 9 to 11 schematically illustrate a working coil, a light guide and an input interface for convenience of description. Additionally, a position of the object subject to heating (HT) in FIG. 11 corresponds to a position of the burner image (FI) for an object subject to heating in FIG. 7.

FIGS. 5 to 11 illustrate a display method an arrangement state of a working coil of the induction heating device 1 in FIG. 1.

When the induction heating device 1 is turned on (i.e., when power starts to be supplied from a power supply), a coil image (e.g., WCI) of each of the plurality of working coils (a00 to a03, a10 to a15, a20 to a25, b00 to b03, b10 to b15 and b20 to b25) may be displayed on the input interface 300.

Specifically, when the induction heating device 1 is turned on, the second control module 320 may control the input interface 300 such that a coil image (e.g., WCI) of each of the plurality of working coils (a00 to a03, a10 to a15, a20 to a25, b00 to b03, b10 to b15 and b20 to b25) is displayed on the input interface 300.

Certainly, the coil image (e.g., WCI) of each of the plurality of working coils (a00 to a03, a10 to a15, a20 to a25, b00 to b03, b10 to b15 and b20 to b25) may be displayed on the input interface 300 to correspond to a position of each of the plurality of working coils (a00 to a03, a10 to a15, a20 to a25, b00 to b03, b10 to b15 and b20 to b25).

For example, a coil image (e.g., WCI) of each of the plurality of working coils (a00 to a03, a10 to a15, a20 to a25, b00 to b03, b10 to b15 and b20 to b25), a setting image (SI) that displays a setting icon (e.g., a temporary stop icon, a screen lock icon, a setting list icon, a timer icon and the like), and an auxiliary image (CI) that displays an auxiliary icon (e.g., a Wi-Fi connection state icon and a current time display icon) may be displayed on the input interface 300.

Additionally, information on an installation position of each of the plurality of working coils (a00 to a03, a10 to a15, a20 to a25, b00 to b03, b10 to b15 and b20 to b25) is pre-stored in the second control module 320 in the step of manufacturing a product. Accordingly, when the induction heating device 1 is turned on, the second control module 320 may control the input interface 300 such that the coil image (e.g., WCI) of each of the plurality of working coils (a00 to a03, a10 to a15, a20 to a25, b00 to b03, b10 to b15 and b20 to b25) is displayed on the input interface 300 on the basis of the stored information. By doing so, the user may figure out about an arrangement state of the plurality of working coils through the input interface 300 as soon as the user turns on the induction heating device 1.

The coil image (WCI) may be displayed on the input interface 300 only for a predetermined period and then may disappear, and, when a working coil starts to be driven, may disappear. Detailed description in relation to this is omitted.

When an object subject to heating (e.g., HT) is placed on an upper plate (115 in FIG. 1) of a cover plate (119 in FIG. 1), the first control module 310 may sense a working coil that has the object subject to heating (HT) at an upper side thereof among the plurality of working coils (a00 to a03, a10 to a15, a20 to a25, b00 to b03, b10 to b15 and b20 to b25).

The first control module 310 may detect a degree of a reduction in resonance currents flowing in each of the plurality of working coils (a00 to a03, a10 to a15, a20 to a25, b00 to b03, b10 to b15 and b20 to b25) is reduced, and, on the basis of results of the detection, may sense a working coil that has the object subject to heating (HT) at an upper side thereof.

When sensing a position of the object subject to heating (HT), the first control module 310 may supply information on the position of the sensed object subject to heating (HT) to the second control module 320.

The information on the position of the sensed object subject to heating (HT) may include information on a degree of a reduction in resonance currents flowing in each working coil (e.g., a22 to a25) where the object subject to heating (HT) is sensed, among the plurality of working coils (a00 to a03, a10 to a15, a20 to a25, b00 to b03, b10 to b15 and b20 to b25).

The second control module 320 may determine whether the object subject to heating (HT), sensed on the basis of the information on the position of the object subject to heating (HT) supplied by the first control module 310, is concentrically placed.

The second control module 320 may determine whether the object subject to heating (HT) is concentrically placed on the basis of the degree of a reduction in resonance currents flowing in the working coil (e.g., a22 to a25) where the object subject to heating (HT) is sensed.

Specifically, in case the degree of a reduction in resonance currents flowing in each working coil (e.g., a22 to a25) where the object subject to heating (HT) is sensed is higher than a predetermined reference value (the case in FIG. 7), the second control module 320 may determine that the sensed object subject to heating (HT) is concentrically placed.

In case the degree of a reduction in resonance currents flowing in at least one working coil (e.g., a22, a24) of the working coils (e.g., a22 to a25) where the object subject to heating (HT) is sensed is lower than the predetermined reference value (the case in FIG. 8), the second control module 320 may determine that the sensed object subject to heating (HT) is eccentrically placed.

Then, the second control module 320 may control the input interface 300 such that a burner image (FI) for the object subject to heating is displayed on the input interface 300 on the basis of results of the determination and the information on the position of the sensed object subject to heating (FI).

The burner image (FI) for the object subject to heating may be displayed in a specific area of the input interface 300 to correspond to the position of the object subject to heating (HT) on the cover plate (119 in FIG. 1), and may be displayed by applying a size and a direction of rotation of the object subject to heating (HT). Additionally, the burner image (FI) for the object subject to heating may be displayed to overlap with the coil image (e.g., WCI) on the input interface 300.

That is, the burner image (FI) for the object subject to heating may be displayed in a specific area of the input interface 300 corresponding to an actual position of the object subject to heating (HT) on the upper plate (115 in FIG. 1) on the basis of a scale of the upper plate (115 in FIG. 1) of the cover plate (119 in FIG. 1) versus the input interface 300.

In case results of the determination (i.e., results of the determination as to whether an object subject to heating (HT) is concentrically placed) indicate that the sensed object subject to heating (HT) is concentrically placed, the second control module 320, as illustrated in FIG. 7, may control the input interface 300 such that the burner image (FI) for the object subject to heating has a first color.

In case results of the determination indicate that the sensed object subject heating (HT) is eccentrically placed, the second control module 320, as illustrated in FIG. 8, may control the input interface 300 such that the burner image (FI) for the object subject to heating has a second color different from the first color.

That is, the user may easily determine whether an object subject to heating (HT) is concentrically placed through a color of a burner image (FI) for the object subject to heating, which is displayed on the input interface 300.

When the induction heating device 1 is turned on, the second control module 320 may turn on or may alternately turn on and turn off all the plurality of light-emitting elements for a predetermined period.

That is, the second control module 320 may turn on or may alternately turn on and turn off all the plurality of light-emitting elements such that a light-emitting surface of a light guide 210 placed at an upper side of the plurality of light-emitting elements maintains a light-emitting state (That is, the light-emitting state in FIG. 9 is maintained.) or flickers (That is, the light-emitting state in FIGS. 9 and 10 is alternately repeated).

Then, in case the predetermined period is over and the first control module 310 does not sense an object subject to heating within the predetermined period, (e.g., when the user does not place an object subject to heating on the upper plate (115 in FIG. 1)), the second control module 320 may turn off all the plurality of light-emitting elements.

In case the predetermined period is over and the first control module 310 senses an object subject to heating (HT), the second control module 320, as illustrated in FIG. 11, may turn on a light-emitting element placed around a lower side of the sensed object subject to heating (HT) and may turn off the rest light-emitting elements among the plurality of light-emitting elements, on the basis of information on a position of the sensed object subject to heating (HT).

Certainly, in case the first control module 310 senses an object subject to heating (HT) before the predetermined period is over, and starts to drive a working coil (e.g., a22 to a25) where the object subject to heating (HT) is sensed among the plurality of working coils, the second control module 320 may turn on a light-emitting element placed around a lower side of the sensed object subject to heating (HT) and may turn off the rest light-emitting elements among the plurality of light-emitting elements, on the basis of information on a position of the sensed object subject to heating (HT).

That is, the second control module 320 may keep turning only on a light-emitting element placed around a working coil (e.g., a22 to a25) where an object subject to heating (HT) is sensed among the plurality of light-emitting elements such that a light-emitting surface of a light guide 210-1 placed at an upper side of the light-emitting element only emits light.

As described above, the user may figure out about an arrangement state of a working coil through the upper plate (115. in FIG. 1) as well as the input interface 300.

In summary, when the induction heating device 1 is turned on, the induction heating device 1 may visually suggest an arrangement state of a working coil to the user using the input interface 300 and the upper place (115 in FIG. 1), thereby making it possible to improve accuracy of a concentric arrangement of an object subject to heating by the user.

As described above, the induction heating device 1 according to an embodiment may improve accuracy of a concentric arrangement of an object subject to heating by a user, thereby reducing the possibility that the object subject to heating is eccentrically placed at an upper side of a working coil and solving problems such as decreased energy efficiency and increased cooking time and the like caused by the eccentric arrangement of the object subject to heating.

The induction heating device 1 according to an embodiment may provide improved user experience and user interface, thereby enhancing user convenience under different conditions.

The present invention has been described with reference to the embodiments illustrated in the drawings. However, the invention is not limited to the embodiments and the drawings set forth herein. Further, various modifications may be made by one having ordinary skill in the art within the scope of the technical spirit of the invention. Further, though not explicitly described during description of the embodiments of the invention, effects and predictable effects according to the configuration of the invention should be included in the scope of the invention.

### INDUSTRIAL APPLICABILITY

The present invention is applicable to an induction heating device that generates eddy currents in an object subject to heating made of a metallic material using a magnetic field which is generated around a coil when predetermined-magnitude high-frequency power is supplied to the coil such that the object subject to heating itself is heated.

1. An induction heating device, comprising:
a case;
a plurality of working coils provided in the case;
a cover plate which is coupled to an upper end of the case and where an object subject to heating heated by at least one of the plurality of working coils is placed on an upper surface thereof;
an input interface flatly buried into the upper surface of the cover plate, configured to receive a touch input from a user, and configured to display a specific image;
a first control module configured to sense which one of the plurality of working coils has the object subject to heating at an upper side thereof, and
a second control module configured to control the input interface such that a coil image of each of the plurality of working coils is displayed on the input interface, and
wherein the second control module receives information on a position of the sensed object subject to heating from the first control module, determines whether the sensed object subject to heating is concentrically placed on the basis of the information on the position of the sensed object subject to heating, and controls the input interface on the basis of results of the determination and on the basis of the information on the position of the sensed object subject to heating such that a burner image for the object subject to heating is displayed on the input interface.

2. The induction heating device of claim 1, wherein, in case the results of the determination indicate a concentric arrangement of the sensed object subject to heating,
the second control module controls the input interface such that the burner image for the object subject to heating has a first color.

3. The induction heating device of claim 2, wherein, in case the results of the determination indicate an eccentric arrangement of the sensed object subject to heating,
the second control module controls the input interface such that the burner image for the object subject to heating has a second color different from the first color.

4. The induction heating device of claim 1, wherein the first control module detects a degree of a reduction in resonance currents flowing in each of the plurality of working coils, and senses a working coil that has the object subject to heating at an upper side thereof on the basis of results of the detection, and
the information on the position of the sensed object subject to heating includes information on a degree of a reduction in resonance currents flowing in each working coil where the object subject to heating is sensed among the plurality of working coils.

5. The induction heating device of claim 4, wherein, in case a degree of a reduction in resonance currents flowing in at least one working coil among working coils where the object subject to heating is sensed is lower than a predetermined reference value,
the second control module determines that the sensed object subject to heating is eccentrically placed.

6. The induction heating device of claim 4, wherein, in case a degree of a reduction in resonance currents flowing in each working coil where the object subject to heating is sensed is higher than a predetermined reference value,
the second control module determines that the sensed object subject to heating is concentrically placed.

7. The induction heating device of claim 1, wherein the burner image for the object subject to heating is displayed on the input interface to overlap with the coil image.

8. The induction heating device of claim 1, further comprising:
a plurality of light guides installed around each of the plurality of working coils and configured to display whether each of the plurality of working coils is driven and to display heating intensity of each of the plurality of working coils; and
a plurality of light-emitting elements controlled by the second control module and provided at a lower side of each of the plurality of light guides to emit light.

9. The induction heating device of claim 8, wherein, when power starts to be supplied from a power supply,
the second control module turns on or alternately turns on and turns off all the plurality of light-emitting elements for a predetermined period.

10. The induction heating device of claim 9, wherein, in case the predetermined period is over and the first control module does not sense an object subject to heating within the predetermined period,
the second control module turns off all the plurality of light-emitting elements.

11. The induction heating device of claim 9, wherein, in case the predetermined period is over and the first control module senses the object subject to heating,
the second control module turns on a light-emitting element around a lower side of the sensed object subject to heating among the plurality of light-emitting elements on the basis of information on a position of the sensed object subject to heating, and turns off the rest light-emitting elements.

12. The induction heating device of claim 9, wherein, in case the first control module senses the object subject to heating before the predetermined period is over and starts to drive a working coil where the object subject to heating is sensed among the plurality of working coils,
the second control module turns on a light-emitting element around a lower side of the sensed object subject to heating among the plurality of light-emitting elements on the basis of the information on the position of the sensed object subject to heating, and turns off the rest light-emitting elements.

13. The induction heating device of claim 1, wherein the burner image for the object subject to heating is displayed in a specific area of the input interface to correspond to the position of the object subject to heating on the cover plate, and is displayed by applying a size and a direction of rotation of the object subject to heating.

14. The induction heating device of claim 1, wherein the second control module receives the touch input from the input interface, and
the first control module receives the touch input from the second control module, and, on the basis of the received touch input, control driving of at least one of the plurality of working coils.
